(19) United States
(12) Patent Application Publication
(10) Pub. No.: US 2018/0041312 A1
(43) Pub. Date: Feb. 8, 2018

(54) INFORMATION FEEDBACK METHOD, DEVICE, AND SYSTEM

(71) Applicant: Huawei Technologies Co., Ltd., Shenzhen (CN)

(72) Inventors: Yuanjie LI, Shanghai (CN); Lixia XUE, Beijing (CN); Yongxing ZHOU, Beijing (CN); Bingyu QU, Beijing (CN)

(21) Appl. No.: 15/786,009

(22) Filed: Oct. 17, 2017

Related U.S. Application Data
(63) Continuation of application No. PCT/CN2015/076885, filed on Apr. 17, 2015.

(51) Int. Cl. H04L 1/18; H04W 72/04; H04B 7/06

(52) U.S. Cl. CPC H04L 1/1861; H04L 1/1812; H04B 7/0636; H04W 72/0446; H04L 5/0055

(57) ABSTRACT

Embodiments of the present disclosure provide an information feedback method. A user equipment (UE) detects downlink transmission data in a received subframe. The UE sends a response message for the downlink transmission data to an access network device, where the response message is sent by the UE on an uplink symbol in a K^{th} subframe after the received subframe, K is the same for any subframe arrangement in a TDD system, and K is a positive integer. The embodiments of the present disclosure are applied to the TDD system. An ACK or NACK feedback time is reduced, thereby greatly reducing a HARQ delay and meeting a transmission requirement for an ultralow delay.

### CROSS-REFERENCE TO RELATED APPLICATIONS

This application is a continuation of International Application No. PCT/CN2015/076885, filed on Apr. 17, 2015, the disclosure of which is hereby incorporated by reference in its entirety.

### TECHNICAL FIELD

The present disclosure relates to the field of communications technologies, and in particular, to an information feedback method, a device, and a system.

### BACKGROUND

A hybrid automatic repeat request (HARQ) is a technology that combines feedforward error correction and an automatic repeat request. HARQ retransmission is based on an acknowledgement (ACK) or a negative acknowledgement (NACK). A HARQ round-trip time difference is defined as a minimum value of a time interval between retransmitted data and the same data transmitted the previous time. For example, in a Long Term Evolution (LTE) frequency division duplex (FDD) system, a HARQ round-trip time difference is 8 ms; in an LTE time division duplex (TDD) system, a HARQ round-trip time difference requires a longer time.

With evolution of wireless communications technologies, a transmission delay is required to be as low as possible. For example, in the industry, an end-to-end transmission delay is required not to exceed 1 ms. In automated driving technologies, an end-to-end delay is required to be less than 5 ms. Apparently, a HARQ round-trip time difference that can be implemented in the prior art cannot meet the foregoing requirement.

### SUMMARY

In view of this, embodiments of the present disclosure provide an information feedback method, a device, and a system, so as to reduce a communication transmission delay as much as possible.

According to a first aspect, an embodiment of the present disclosure provides an information feedback method, applied to a time division duplex TDD system and including: detecting, by user equipment UE, downlink transmission data in a received subframe; and sending, by the UE, a response message for the downlink transmission data to the access network device, where the response message is sent by the UE on an uplink symbol in a K^{th} subframe after the received subframe, K is the same for any subframe arrangement in the TDD system, and K is a positive integer.

With reference to the first aspect, in a first implementation of the first aspect, the K^{th} subframe includes an uplink symbol and a downlink symbol.

With reference to the first aspect and the foregoing implementation of the first aspect, in a second implementation of the first aspect, the uplink symbol in the K^{th} subframe is located before the downlink symbol in the subframe.

With reference to the first aspect and the foregoing implementation of the first aspect, in a third implementation of the first aspect, the downlink symbol in the K^{th} subframe is located before the uplink symbol in the subframe, there are multiple uplink symbols in the subframe, a guard period exists between the downlink symbol and the uplink symbol in the subframe, and the response message is carried on any uplink symbol after the guard period or on at least two uplink symbols after the guard period.

With reference to the first aspect and the foregoing implementation of the first aspect, in a fourth implementation of the first aspect, the downlink symbol in the K^{th} subframe is located before the uplink symbol in the subframe, there is one uplink symbol in the subframe, and a guard period exists between the downlink symbol and the uplink symbol in the subframe.

With reference to the first aspect and the foregoing implementation, in a fifth implementation of the first aspect, the response message is an acknowledgement ACK message or a negative acknowledgement NACK message.

According to a second aspect, an embodiment of the present disclosure provides user equipment, where the user equipment is applied to a time division duplex TDD system and includes: a detection unit, configured to detect downlink transmission data in a received subframe; and a sending unit, configured to send a response message for the downlink transmission data to the access network device, where the response message is sent by the user equipment on an uplink symbol in a K^{th} subframe after the received subframe, K is the same for any subframe arrangement in the TDD system, and K is a positive integer.

With reference to the second aspect, in a first implementation of the second aspect, the K^{th} subframe includes an uplink symbol and a downlink symbol.

With reference to the second aspect and the foregoing implementation of the second aspect, in a second implementation of the second aspect, the uplink symbol in the K^{th} subframe is located before the downlink symbol in the subframe.

With reference to the second aspect and the foregoing implementation of the second aspect, in a third implementation of the second aspect, the downlink symbol in the K^{th} subframe is located before the uplink symbol in the subframe, there are multiple uplink symbols in the subframe, a guard period exists between the downlink symbol and the uplink symbol in the subframe, and the response message is carried on any uplink symbol after the guard period or on at least two uplink symbols after the guard period.

With reference to the second aspect and the foregoing implementation of the second aspect, in a fourth implementation of the second aspect, the downlink symbol in the K^{th} subframe is located before the uplink symbol in the subframe, there is one uplink symbol in the subframe, and a guard period exists between the downlink symbol and the uplink symbol in the subframe.

With reference to the second aspect and the foregoing implementation of the second aspect, in a fifth implementation of the second aspect, the response message is an acknowledgement ACK message or a negative acknowledgement NACK message.

According to a third aspect, an embodiment of the present disclosure provides user equipment, applied to a time division duplex TDD system, where the user equipment includes a receiver, a processor, a bus, a memory, and transmitter, where the processor obtains an instruction in the memory by using the bus, so as to detect downlink transmission data in a received subframe; and the transmitter is configured to send a response message for the downlink transmission data to the access network device, where the response message is sent by the receiver on an uplink symbol in a K^{th} subframe after the received subframe, K is the same for any subframe arrangement in the TDD system, and K is a positive integer.

With reference to the third aspect, in a first implementation of the third aspect, the K^{th} subframe includes an uplink symbol and a downlink symbol.

With reference to the third aspect and the foregoing implementation of the third aspect, in a second implementation of the third aspect, the uplink symbol in the K^{th} subframe is located before the downlink symbol in the subframe.

With reference to the third aspect and the foregoing implementation of the third aspect, in a third implementation of the third aspect, the downlink symbol in the K^{th} subframe is located before the uplink symbol in the subframe, there are multiple uplink symbols in the subframe, a guard period exists between the downlink symbol and the uplink symbol in the subframe, and the response message is carried on any uplink symbol after the guard period or on at least two uplink symbols after the guard period.

With reference to the third aspect and the foregoing implementation of the third aspect, in a fourth implementation of the third aspect, the downlink symbol in the K^{th} subframe is located before the uplink symbol in the subframe, there is one uplink symbol in the subframe, and a guard period exists between the downlink symbol and the uplink symbol in the subframe.

With reference to the third aspect and the foregoing implementation of the third aspect, in a fifth implementation of the third aspect, the response message is an acknowledgement ACK message or a negative acknowledgement NACK message.

According to a fourth aspect, an embodiment of the present disclosure provides a chip system, applied to a time division duplex TDD system and including at least one processor, a memory, an input/output part, and a bus, where the at least one processor obtains an instruction in the memory by using the bus, so as to detect downlink transmission data in a received subframe; and the input/output part is configured to send a response message for the downlink transmission data to the access network device, where the response message is sent by the input/output part on an uplink symbol in a K^{th} subframe after the received subframe, K is the same for any subframe arrangement in the TDD system, K is a positive integer, and the response message is a hybrid automatic repeat request response message.

With reference to the fourth aspect, in a first implementation of the fourth aspect, the K^{th} subframe includes an uplink symbol and a downlink symbol.

With reference to the fourth aspect and the foregoing implementation of the fourth aspect, in a first implementation of the fourth aspect, the uplink symbol in the K^{th} subframe is located before the downlink symbol in the subframe.

With reference to the fourth aspect and the foregoing implementation of the fourth aspect, in a second implementation of the fourth aspect, the downlink symbol in the K^{th} subframe is located before the uplink symbol in the subframe, there are multiple uplink symbols in the subframe, a guard period exists between the downlink symbol and the uplink symbol in the subframe, and the response message is carried on any uplink symbol after the guard period or on at least two uplink symbols after the guard period.

With reference to the fourth aspect and the foregoing implementation of the fourth aspect, in a third implementation of the fourth aspect, the downlink symbol in the K^{th} subframe is located before the uplink symbol in the subframe, there is one uplink symbol in the subframe, and a guard period exists between the downlink symbol and the uplink symbol in the subframe.

With reference to the fourth aspect and the foregoing implementation of the fourth aspect, in a fourth implementation of the fourth aspect, the response message is an acknowledgement ACK message or a negative acknowledgement NACK message.

According to a fifth aspect, an embodiment of the present disclosure provides another information feedback method, applied to a time division duplex TDD system, where the method includes: sending, by an access network device, a subframe to user equipment UE, where the subframe carries downlink transmission data; and receiving, by the access network device from the UE, a response message for the downlink transmission data, where the response message is sent on an uplink symbol in a K^{th} subframe after the subframe sent by the access network device, K is the same for any subframe arrangement in the TDD system, and K is a positive integer.

With reference to the fifth aspect, in a first implementation of the fifth aspect, the K^{th} subframe includes an uplink symbol and a downlink symbol.

With reference to the fifth aspect and the foregoing implementation of the fifth aspect, in a second implementation of the fifth aspect, the uplink symbol in the K^{th} subframe is located before the downlink symbol in the subframe.

With reference to the fifth aspect and the foregoing implementation of the fifth aspect, in a third implementation of the fifth aspect, the downlink symbol in the K^{th} subframe is located before the uplink symbol in the subframe, there are multiple uplink symbols in the subframe, a guard period exists between the downlink symbol and the uplink symbol in the subframe, and the response message is carried on any uplink symbol after the guard period or on at least two uplink symbols after the guard period.

With reference to the fifth aspect and the foregoing implementation of the fifth aspect, in a fourth implementation of the fifth aspect, the downlink symbol in the K^{th} subframe is located before the uplink symbol in the subframe, there is one uplink symbol in the subframe, and a guard period exists between the downlink symbol and the uplink symbol in the subframe.

With reference to the fifth aspect and the foregoing implementation of the fifth aspect, in a fifth implementation of the fifth aspect, the response message is an acknowledgement ACK message or a negative acknowledgement NACK message.

According to a sixth aspect, an embodiment of the present disclosure provides an access network device, where the access network device is applied to a time division duplex TDD system and includes: a sending unit, configured to send a subframe to user equipment UE, where the subframe carries downlink transmission data; and a receiving unit, configured to receive, from the UE, a response message for the downlink transmission data, where the response message is sent on an uplink symbol in a K^{th} subframe after the subframe sent by the access network device, K is the same for any subframe arrangement in the TDD system, and K is a positive integer.

With reference to the sixth aspect, in a first implementation of the sixth aspect, the K^{th} subframe includes an uplink symbol and a downlink symbol.

With reference to the sixth aspect and the foregoing implementation of the sixth aspect, in a second implementation of the sixth aspect, the uplink symbol in the K^{th} subframe is located before the downlink symbol in the subframe.

With reference to the sixth aspect and the foregoing implementation of the sixth aspect, in a third implementation of the sixth aspect, the downlink symbol in the K^{th} subframe is located before the uplink symbol in the subframe, there are multiple uplink symbols in the subframe, a guard period exists between the downlink symbol and the uplink symbol in the subframe, and the response message is carried on any uplink symbol after the guard period or on at least two uplink symbols after the guard period.

With reference to the sixth aspect and the foregoing implementation of the sixth aspect, in a fourth implementation of the sixth aspect, the downlink symbol in the K^{th} subframe is located before the uplink symbol in the subframe, there is one uplink symbol in the subframe, and a guard period exists between the downlink symbol and the uplink symbol in the subframe.

With reference to the sixth aspect and the foregoing implementation of the sixth aspect, in a fifth implementation of the sixth aspect, the response message is an acknowledgement ACK message or a negative acknowledgement NACK message.

According to a seventh aspect, an embodiment of the present disclosure provides an access network device, applied to a time division duplex TDD system, where the access network device includes a receiver, a processor, a bus, a memory, and transmitter, where the transmitter is configured to send a subframe to user equipment UE, where the subframe carries downlink transmission data; and the receiver is configured to receive, from the UE, a response message for the downlink transmission data, where the response message is sent on an uplink symbol in a K^{th} subframe after the subframe sent by the transmitter, K is the same for any subframe arrangement in the TDD system, and K is a positive integer.

With reference to the seventh aspect, in a first implementation of the seventh aspect, the K^{th} subframe includes an uplink symbol and a downlink symbol.

With reference to the seventh aspect and the foregoing implementation of the seventh aspect, in a second implementation of the seventh aspect, the uplink symbol in the K^{th} subframe is located before the downlink symbol in the subframe.

With reference to the seventh aspect and the foregoing implementation of the seventh aspect, in a third implementation of the seventh aspect, the downlink symbol in the K^{th} subframe is located before the uplink symbol in the subframe, there are multiple uplink symbols in the subframe, a guard period exists between the downlink symbol and the uplink symbol in the subframe, and the response message is carried on any uplink symbol after the guard period or on at least two uplink symbols after the guard period.

With reference to the seventh aspect and the foregoing implementation of the seventh aspect, in a fourth implementation of the seventh aspect, the downlink symbol in the K^{th} subframe is located before the uplink symbol in the subframe, there is one uplink symbol in the subframe, and a guard period exists between the downlink symbol and the uplink symbol in the subframe.

With reference to the seventh aspect and the foregoing implementation of the seventh aspect, in a fifth implementation of the seventh aspect, the response message is an acknowledgement ACK message or a negative acknowledgement NACK message.

According to an eighth aspect, an embodiment of the present disclosure provides a chip system, applied to a time division duplex TDD system and including at least one processor, a memory, an input/output part, and a bus, where the input/output part is configured to send a subframe to user equipment UE, where the subframe carries downlink transmission data, and is further configured to receive, from the UE, a response message for the downlink transmission data, where the response message is sent on an uplink symbol in a K^{th} subframe after the subframe sent by the input/output part, K is the same for any subframe arrangement in the TDD system, K is a positive integer, and the response message is a hybrid automatic repeat request response message.

With reference to the eighth aspect, in a first implementation of the eighth aspect, the K^{th} subframe includes an uplink symbol and a downlink symbol.

With reference to the eighth aspect and the foregoing implementation of the eighth aspect, in a second implementation of the eighth aspect, the uplink symbol in the K^{th} subframe is located before the downlink symbol in the subframe.

With reference to the eighth aspect and the foregoing implementation of the eighth aspect, in a third implementation of the eighth aspect, the downlink symbol in the K^{th} subframe is located before the uplink symbol in the subframe, there are multiple uplink symbols in the subframe, a guard period exists between the downlink symbol and the uplink symbol in the subframe, and the response message is carried on any uplink symbol after the guard period or on at least two uplink symbols after the guard period.

With reference to the eighth aspect and the foregoing implementation of the eighth aspect, in a fourth implementation of the eighth aspect, the downlink symbol in the K^{th} subframe is located before the uplink symbol in the subframe, there is one uplink symbol in the subframe, and a guard period exists between the downlink symbol and the uplink symbol in the subframe.

With reference to the eighth aspect and the foregoing implementation of the eighth aspect, in a fifth implementation of the eighth aspect, the response message is an acknowledgement ACK message or a negative acknowledgement NACK message.

According to a ninth aspect, an embodiment of the present disclosure provides an information feedback method, applied to a time division duplex TDD system, where the method includes: detecting, by an access network device, uplink transmission data in a subframe according to the subframe that is indicated by downlink control signaling and used by user equipment UE for uplink data transmission; and sending, by the access network device, a response message for the uplink transmission data to the UE, where the response message is sent on a downlink symbol in a K^{th} subframe after the subframe detected by the access network device, K is the same for any subframe arrangement in the TDD system, and K is a positive integer.

With reference to the ninth aspect, in a first implementation of the ninth aspect, the K^{th} subframe includes an uplink symbol and a downlink symbol.

With reference to the ninth aspect and the foregoing implementation of the ninth aspect, in a second implementation of the ninth aspect, the uplink symbol in the K^{th} subframe is located before the downlink symbol in the subframe, there are multiple downlink symbols in the subframe, and the response message is carried on the first downlink symbol after the uplink symbol in the subframe or on at least two downlink symbols after the uplink symbol in the subframe.

With reference to the ninth aspect and the foregoing implementation of the ninth aspect, in a third implementation of the ninth aspect, the downlink symbol in the K^{th} subframe is located before the uplink symbol in the subframe, and a guard period exists between the downlink symbol and the uplink symbol in the subframe.

With reference to the ninth aspect and the foregoing implementation of the ninth aspect, in a fourth implementation of the ninth aspect, the response message is an acknowledgement ACK message or a negative acknowledgement NACK message.

According to a tenth aspect, an embodiment of the present disclosure provides another access network device, where the access network device is applied to a time division duplex TDD system and includes: a detection unit, configured to detect uplink transmission data in a subframe according to the subframe that is indicated by downlink control signaling and used by user equipment UE for uplink data transmission; and a sending unit, configured to send a response message for the uplink transmission data to the UE, where the response message is sent on a downlink symbol in a K^{th} subframe after the subframe detected by the access network device, and K is the same for any subframe arrangement in the TDD system, and K is a positive integer.

With reference to the tenth aspect, in a first implementation of the tenth aspect, the K^{th} subframe includes an uplink symbol and a downlink symbol.

With reference to the tenth aspect and the foregoing implementation of the tenth aspect, in a second implementation of the tenth aspect, the uplink symbol in the K^{th} subframe is located before the downlink symbol in the subframe, there are multiple downlink symbols in the subframe, and the response message is carried on the first downlink symbol after the uplink symbol in the subframe or on at least two downlink symbols after the uplink symbol in the subframe.

With reference to the tenth aspect and the foregoing implementation of the tenth aspect, in a third implementation of the tenth aspect, the downlink symbol in the K^{th} subframe is located before the uplink symbol in the subframe, and a guard period exists between the downlink symbol and the uplink symbol in the subframe.

With reference to the tenth aspect and the foregoing implementation of the tenth aspect, in a fourth implementation of the tenth aspect, the response message is an acknowledgement ACK message or a negative acknowledgement NACK message.

According to an eleventh aspect, an embodiment of the present disclosure provides another access network device, applied to a time division duplex TDD system, where the access network device includes a receiver, a processor, a bus, a memory, and transmitter, where the processor obtains an instruction in the memory by using the bus, so as to detect uplink transmission data in a subframe according to the subframe that is indicated by downlink control signaling and used by user equipment UE for uplink data transmission; and the transmitter is configured to send a response message for the uplink transmission data to the UE, where the response message is sent on a downlink symbol in a K^{th} subframe after the subframe detected by the processor, K is the same for any subframe arrangement in the TDD system, and K is a positive integer.

With reference to the eleventh aspect, in a first implementation of the eleventh aspect, the K^{th} subframe includes an uplink symbol and a downlink symbol.

With reference to the eleventh aspect and the foregoing implementation of the eleventh aspect, in a second implementation of the eleventh aspect, the uplink symbol in the K^{th} subframe is located before the downlink symbol in the subframe, there are multiple downlink symbols in the subframe, and the response message is carried on the first downlink symbol after the uplink symbol in the subframe or on at least two downlink symbols after the uplink symbol in the subframe.

With reference to the eleventh aspect and the foregoing implementation of the eleventh aspect, in a third implementation of the eleventh aspect, the downlink symbol in the K^{th} subframe is located before the uplink symbol in the subframe, and a guard period exists between the downlink symbol and the uplink symbol in the subframe.

With reference to the eleventh aspect and the foregoing implementation of the eleventh aspect, in a fourth implementation of the eleventh aspect, the response message is an acknowledgement ACK message or a negative acknowledgement NACK message.

According to a twelfth aspect, an embodiment of the present disclosure provides a chip system, applied to a time division duplex TDD system and including at least one processor, a memory, an input/output part, and a bus, where the at least one processor obtains an instruction in the memory by using the bus, so as to detect uplink transmission data in a subframe according to the subframe that is indicated by downlink control signaling and used by user equipment UE for uplink data transmission; and the input/output part is configured to send a response message for the uplink transmission data to the UE, where the response message is sent on a downlink symbol in a K^{th} subframe after the subframe detected by the processor, K is the same for any subframe arrangement in the TDD system, K is a positive integer, and the response message is a hybrid automatic repeat request response message.

With reference to the twelfth aspect, in a first implementation of the twelfth aspect, the K^{th} subframe includes an uplink symbol and a downlink symbol.

With reference to the twelfth aspect and the foregoing implementation of the twelfth aspect, in a second implementation of the twelfth aspect, the uplink symbol in the K^{th} subframe is located before the downlink symbol in the subframe, there are multiple downlink symbols in the subframe, and the response message is carried on the first downlink symbol after the uplink symbol in the subframe or on at least two downlink symbols after the uplink symbol in the subframe.

With reference to the twelfth aspect and the foregoing implementation of the twelfth aspect, in a third implementation of the twelfth aspect, the downlink symbol in the K^{th} subframe is located before the uplink symbol in the subframe, and a guard period exists between the downlink symbol and the uplink symbol in the subframe.

With reference to the twelfth aspect and the foregoing implementation of the twelfth aspect, in a fourth implementation of the twelfth aspect, the response message is an acknowledgement ACK message or a negative acknowledgement NACK message.

According to a thirteenth aspect, an embodiment of the present disclosure provides an information feedback method, applied to a time division duplex TDD system, where the method includes: sending, by user equipment UE, a subframe to an access network device according to downlink control signaling, where the subframe carries uplink transmission data; and receiving, by the UE from the access network device, a response message for the uplink transmission data, where the response message is sent on a downlink symbol in a K^{th} subframe after the subframe sent by the UE, K is the same for any subframe arrangement in the TDD system, and K is a positive integer.

With reference to the thirteenth aspect, in a first implementation of the thirteenth aspect, the K^{th} subframe includes an uplink symbol and a downlink symbol.

With reference to the thirteenth aspect and the foregoing implementation of the thirteenth aspect, in a second implementation of the thirteenth aspect, the uplink symbol in the K^{th} subframe is located before the downlink symbol in the subframe, there are multiple downlink symbols in the subframe, and the response message is carried on the first downlink symbol after the uplink symbol in the subframe or on at least two downlink symbols after the uplink symbol in the subframe.

With reference to the thirteenth aspect and the foregoing implementation of the thirteenth aspect, in a third implementation of the thirteenth aspect, the downlink symbol in the K^{th} subframe is located before the uplink symbol in the subframe, and a guard period exists between the downlink symbol and the uplink symbol in the subframe.

With reference to the thirteenth aspect and the foregoing implementation of the thirteenth aspect, in a fourth implementation of the thirteenth aspect, the response message is an acknowledgement ACK message or a negative acknowledgement NACK message.

According to a fourteenth aspect, an embodiment of the present disclosure provides another user equipment, where the user equipment is applied to a time division duplex TDD system and includes: a sending unit, configured to send a subframe to an access network device according to downlink control signaling, where the subframe carries uplink transmission data; and a receiving unit, configured to receive, from the access network device, a response message for the uplink transmission data, where the response message is sent on a downlink symbol in a K^{th} subframe after the subframe sent by the user equipment, K is the same for any subframe arrangement in the TDD system, and K is a positive integer.

With reference to the fourteenth aspect, in a first implementation of the fourteenth aspect, the K^{th} subframe includes an uplink symbol and a downlink symbol.

With reference to the fourteenth aspect and the foregoing implementation of the fourteenth aspect, in a second implementation of the fourteenth aspect, the uplink symbol in the K^{th} subframe is located before the downlink symbol in the subframe, there are multiple downlink symbols in the subframe, and the response message is carried on the first downlink symbol after the uplink symbol in the subframe or on at least two downlink symbols after the uplink symbol in the subframe.

With reference to the fourteenth aspect and the foregoing implementation of the fourteenth aspect, in a third implementation of the fourteenth aspect, the downlink symbol in the K^{th} subframe is located before the uplink symbol in the subframe, and a guard period exists between the downlink symbol and the uplink symbol in the subframe.

With reference to the fourteenth aspect and the foregoing implementation of the fourteenth aspect, in a fourth implementation of the fourteenth aspect, the response message is an acknowledgement ACK message or a negative acknowledgement NACK message.

According to a fifteenth aspect, an embodiment of the present disclosure provides another user equipment, applied to a time division duplex TDD system, where the user equipment includes a receiver, a processor, a bus, a memory, and transmitter, where the transmitter is configured to send a subframe to an access network device according to downlink control signaling, where the subframe carries uplink transmission data; and the receiver is configured to receive, from the access network device, a response message for the uplink transmission data, where the response message is sent on a downlink symbol in a K^{th} subframe after the subframe sent by the transmitter, K is the same for any subframe arrangement in the TDD system, and K is a positive integer.

With reference to the fifteenth aspect, in a first implementation of the fifteenth aspect, the K^{th} subframe includes an uplink symbol and a downlink symbol.

With reference to the fifteenth aspect and the foregoing implementation of the fifteenth aspect, in a second implementation of the fifteenth aspect, the uplink symbol in the K^{th} subframe is located before the downlink symbol in the subframe, there are multiple downlink symbols in the subframe, and the response message is carried on the first downlink symbol after the uplink symbol in the subframe or on at least two downlink symbols after the uplink symbol in the subframe.

With reference to the fifteenth aspect and the foregoing implementation of the fifteenth aspect, in a third implementation of the fifteenth aspect, the downlink symbol in the K^{th} subframe is located before the uplink symbol in the subframe, and a guard period exists between the downlink symbol and the uplink symbol in the subframe.

With reference to the fifteenth aspect and the foregoing implementation of the fifteenth aspect, in a fourth implementation of the fifteenth aspect, the response message is an acknowledgement ACK message or a negative acknowledgement NACK message.

According to a sixteenth aspect, an embodiment of the present disclosure provides another chip system, applied to a time division duplex TDD system and including at least one processor, a memory, an input/output part, and a bus, where the input/output part is configured to send a subframe to an access network device according to downlink control signaling, where the subframe carries uplink transmission data, and is further configured to receive, from the access network device, a response message for the uplink transmission data, where the response message is sent on a downlink symbol in a K^{th} subframe after the subframe sent by the input/output part, K is the same for any subframe arrangement in the TDD system, K is a positive integer, and the response message is a hybrid automatic repeat request response message.

With reference to the sixteenth aspect, in a first implementation of the sixteenth aspect, the K^{th} subframe includes an uplink symbol and a downlink symbol.

With reference to the sixteenth aspect and the foregoing implementation of the sixteenth aspect, in a second implementation of the sixteenth aspect, the uplink symbol in the K^{th} subframe is located before the downlink symbol in the subframe, there are multiple downlink symbols in the subframe, and the response message is carried on the first downlink symbol after the uplink symbol in the subframe or on at least two downlink symbols after the uplink symbol in the subframe.

With reference to the sixteenth aspect and the foregoing implementation of the sixteenth aspect, in a third implementation of the sixteenth aspect, the downlink symbol in the K^{th} subframe is located before the uplink symbol in the subframe, and a guard period exists between the downlink symbol and the uplink symbol in the subframe.

With reference to the sixteenth aspect and the foregoing implementation of the sixteenth aspect, in a fourth implementation of the sixteenth aspect, the response message is an acknowledgement ACK message or a negative acknowledgement NACK message.

According to a seventeenth aspect, an embodiment of the present disclosure provides a communications system, where the communications system includes user equipment and an access network device, where the user equipment is the user equipment according to the second aspect or the third aspect; and
the access network device is the access network device according to the sixth aspect or the seventh aspect.

According to an eighteenth aspect, an embodiment of the present disclosure provides another communications system, where the communications system includes user equipment and an access network device, where the access network device is the access network device according to the tenth aspect or the eleventh aspect; and the user equipment is the user equipment according to the fourteenth aspect or the fifteenth aspect.

A value of K in the first aspect to the eighteenth aspect may be 1, 2, 3, or 4, and the subframe arrangement is a ratio of a subframe type in a configuration manner.

According to the technical solutions provided in the embodiments of the present disclosure, in a TDD system, a feedback message is sent in a K^{th} subframe after a subframe for transmitting data, thereby reducing HARQ feedback complexity. In addition, an ACK or NACK feedback time is shortened by setting K, thereby greatly reducing a HARQ delay and meeting a transmission requirement for an ultralow delay. Meanwhile, by further improving a subframe structure, not only a processing time of a data receiving party is increased, but also a relatively short feedback delay can still be retained. Therefore, a desirable beneficial effect is achieved.

### BRIEF DESCRIPTION OF DRAWINGS

To describe the technical solutions in the embodiments of the present disclosure more clearly, the following briefly describes the accompanying drawings required for describing the embodiments. Apparently, the accompanying drawings in the following description show merely some embodiments of the present disclosure, and a person skilled in the art may still derive other drawings from these accompanying drawings without creative efforts.

FIG. 1 is a structural diagram of a subframe according to an embodiment of the present disclosure;

FIG. 2 is a flowchart of an information feedback method according to an embodiment of the present disclosure;

FIG. 3 is a structural diagram of an improved subframe of a first type according to an embodiment of the present disclosure;

FIG. 4 is a flowchart of another information feedback method according to an embodiment of the present disclosure;

FIG. 5 is a schematic structural diagram of user equipment according to an embodiment of the present disclosure;

FIG. 6 is a schematic structural diagram of an access network device according to an embodiment of the present disclosure;

FIG. 7 is a schematic structural diagram of another access network device according to an embodiment of the present disclosure;

FIG. 8 is a schematic structural diagram of another user equipment according to an embodiment of the present disclosure;

FIG. 9 is a schematic structural diagram of another user equipment according to an embodiment of the present disclosure;

FIG. 10 is a schematic structural diagram of another access network device according to an embodiment of the present disclosure;

FIG. 11 is a schematic structural diagram of another access network device according to an embodiment of the present disclosure; and

FIG. 12 is a schematic structural diagram of another user equipment according to an embodiment of the present disclosure.

### DESCRIPTION OF EMBODIMENTS

To make technical solutions of embodiments of the present disclosure clearer, the following clearly describes the technical solutions in the embodiments of the present disclosure with reference to the accompanying drawings in the embodiments of the present disclosure. Apparently, the following embodiments are a part rather than all of the embodiments of the present disclosure.

The technical solutions provided in the embodiments of the present disclosure may be applied to various wireless communications networks, for example, Code Division Multiple Access (CDMA), Frequency Division Multiple Access (FDMA), orthogonal frequency division multiple access (OFDMA), single carrier frequency division multiple access (SC-FDMA), and another network. The terms “network” and “system” can be interchanged with each other. A CDMA network may implement wireless technologies such as universal terrestrial radio access (UTRA) and CDMA2000. The UTRA may include CDMA (WCDMA) or another variant of CDMA. CDMA2000 can cover Interim Standard (IS) 2000 (IS-2000), IS-95, and IS-856 standards. An OFDMA network may implement wireless technologies such as evolved universal terrestrial radio access (E-UTRA, Ultra Mobile Broadband (UMB), and Flash OFDMA. The UTRA and the E-UTRA are UMTS and an evolved version of UMTS. 3GPP uses a new version of UMTS of E-UTRA in Long Term Evolution (LTE) and LTE Advanced (LTE-A). UTRA, E-UTRA, UMTS, LTE, LTE-A, and GSM are recorded and described in documents of the 3GPP standard organization. CDMA2000 and UMB are recorded and described in documents of the 3GPP2 standard organization. Technologies described in the embodiments of the present disclosure may also be applied to the foregoing wireless networks and wireless technologies.

A communications system provided in the embodiments of the present disclosure includes an access network device and user equipment (UE). The access network device and the UE may be configured to implement methods provided in the following embodiments of the present disclosure. The access network device may provide communication coverage in a specific physical area to provide wireless access for the UE, so that the UE can access a network and perform communication. The access network device may be a device such as a base station, and may be a macro base station or a small cell. For example, in an LTE system, the access network device may be an eNodeB, or may be a small cell such as a home eNodeB (HeNB), an AP, a micro base station, or a pico base station. In a UMTS system, the access network device may include a Node B and a radio network controller (RNC). In a GSM system, the access network device may include a base station controller (BSC) and a base transceiver station (BTS). The UEs may be distributed in an entire wireless network, and each UE may be still or moving. The UE may be referred to as a terminal, a mobile station, a subscriber unit, a station, or the like. The UE may be a cellular phone, a personal digital assistant (PDA) a wireless modem, radio communications equipment, a handheld device, a laptop computer, a cordless phone, a wireless local loop (WLL), or the like.

A HARQ feedback mechanism of an LTE TDD system in the prior art is quite complex, different uplink-downlink configurations correspond to different HARQ delays (because each subframe other than few existing special subframes is unlikely to have both an uplink channel and a downlink channel), and a length of each subframe is 1 ms. Therefore, even a minimum delay reaches 4 ms. This is apparently unsatisfactory for an increasingly rigorous low transmission delay indicator in a communications system.

According to the technical solutions provided in the embodiments of the present disclosure, in a TDD system, a feedback message is sent in a K^{th} subframe after a subframe for transmitting data, thereby reducing HARQ feedback complexity. In addition, an ACK or NACK feedback time is shortened by setting K, thereby greatly reducing a HARQ delay and meeting a transmission requirement for an ultralow delay.

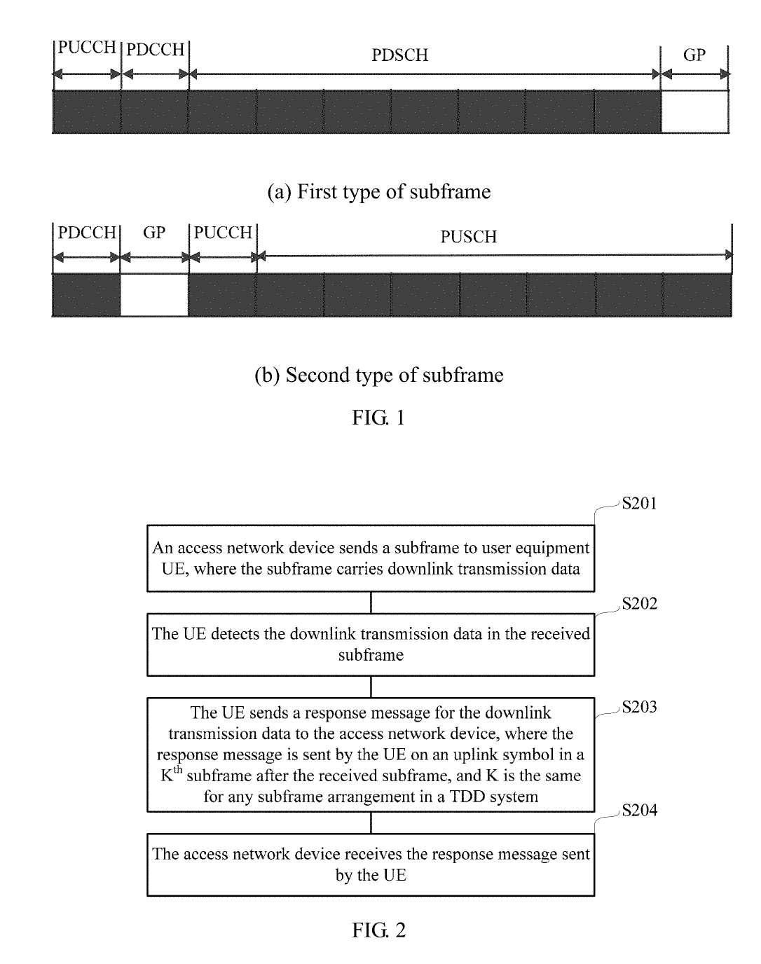

The technical solutions provided in the embodiments of the present disclosure are mainly applied to a TDD system, and in particular, to a system that performs data transmission by using a subframe structure shown in FIG. 1. The technical solutions may be applied to a single-carrier system and a multi-carrier system, and may also be applied to a high frequency (for example, a band higher than 6 GHz) communications system and a low frequency (for example, a band lower than 6 GHz) communications system.

FIG. 1 shows two types of subframe structures. The two types of subframe structures differ from an existing TDD subframe structure in that for the two types of subframe structures, each subframe includes an uplink symbol and a downlink symbol. That is, uplink transmission or downlink transmission may be performed in any subframe, or uplink transmission and downlink transmission may be performed in any subframe at the same time. The two types of subframe structures can shorten a length of each subframe. For example, each subframe may have only 0.2 ms. The two types of subframe structures make it possible to reduce a HARQ delay.

Optionally, the uplink symbol and the downlink symbol are orthogonal frequency division multiplexing (OFDM) symbols or single carrier frequency division multiple access (SC-FDMA) symbols.

It may be understood that a physical uplink control channel (PUCCH) and a physical uplink shared channel (PUSCH) include uplink symbols; and a physical downlink control channel (PDCCH) and a physical downlink shared channel (PDSCH) include downlink symbols.

FIG. 1(a) shows a first type of subframe, and the first type of subframe may include a PUCCH, a PDCCH, a PDSCH, and a guard period (GP). A time sequence of the PUCCH, the PDCCH, the PDSCH, and the GP from left to right may be shown in FIG. 1(a), and each block may represent a time of one symbol.

FIG. 1(b) shows a second type of subframe, and the second type of subframe may include a PDCCH, a GP, a PUCCH, and a PUSCH. A time sequence of the PUCCH, the PDCCH, the PDSCH, and the GP from left to right may be shown in FIG. 1(b), and each block may represent a time of one symbol.

Certainly, different arrangements may be performed on an uplink symbol, a downlink symbol, and a GP in a subframe according to a specific system requirement and a time sequence, provided that it is ensured that each subframe has an uplink symbol and a downlink symbol. This is not limited herein.

In addition, in a same subframe, no limitation is imposed on a quantity of consecutive uplink symbols in the subframe, a quantity of consecutive e downlink symbols in the subframe, and a quantity of symbols occupied by a GP in the subframe.

FIG. 2 is a flowchart of an information feedback method according to an embodiment of the present disclosure. The method is applied to downlink data transmission, an access network device side sends downlink transmission data, and a UE side feeds back a response message indicating whether the downlink transmission data needs to be retransmitted. The method includes the following steps:

S201. An access network device sends a subframe to user equipment UE, where the subframe carries downlink transmission data.

S202. The UE detects the downlink transmission data in the received subframe.

S203. The UE sends a response message for the downlink transmission data to the access network device, where the response message is sent by the UE on an uplink symbol in a K^{th} subframe after the received subframe, and K is the same for any subframe arrangement in the TDD system.

S204. The access network device receives the response message sent by the UE.

Generally, signaling transmission or data transmission between the access network device and the UE is described by using a subframe as a time unit.

A manner of data exchange between the access network device and the UE may be that, when the access network device needs to transmit data to the UE in a downlink manner, the access network device sends, in a subframe at an n^{th} moment, downlink control signaling and downlink transmission data. The downlink control signaling is used to inform the UE that the access network device has downlink data to be transmitted. Optionally, the downlink control signaling includes: a downlink grant (DL Grant), which is used to indicate a time (that is, a subframe in which the downlink transmission data is located) for receiving the downlink transmission data by the UE, specific frequency information of the downlink transmission data or a modulation and coding scheme, and the like.

The UE attempts to receive the downlink transmission data according to the downlink control signaling. When the UE correctly receives the downlink transmission data, the UE needs to feed back an ACK to the access network device. When the UE does not correctly receive the downlink transmission data, the UE needs to feed back a NACK to the access network device. The ACK or the NACK is a response message indicating whether transmission data is correctly received.

In this embodiment of the present disclosure, the response message is sent in a fixed period after the access network device sends the downlink transmission data. For example, as previously described, when the access network device sends, in the subframe at the n^{th} moment, the downlink control signaling and the downlink transmission data, the UE may feed back the response message in an uplink manner in a subframe at an (n+K)^{th} moment. K is a positive integer. The technical solutions provided in this embodiment of the present disclosure are intended to shorten a feedback time of the response message. Therefore, a shorter fixed period indicates a better effect, that is, a smaller value of K indicates a better effect. In actual application, a value of K may be 1, 2, 3, or 4.

When the UE feeds back the response message, the response message may be carried on an uplink symbol in a subframe. Optionally, the UE may use two types of subframes shown in FIG. 1 to feed back the response message to the access network device.

### (1) Feeding Back the Response Message by Using a First Type of Subframe

The response message may be carried on the first symbol in the first type of subframe, that is, the response message is sent to the access network device by using a PUCCH.

When a PUCCH of a subframe of this type is extended to multiple consecutive uplink symbols, the response message may be accordingly carried on the multiple uplink symbols.

### (2) Feeding Back the Response Message by Using a Second Type of Subframe

The response message may be carried on any uplink symbol after a guard period in the second type of subframe or on at least two uplink symbols after the guard period. Optionally, the response message may be carried on the first uplink symbol after a GP in the second type of subframe, that is, the response message is sent to the access network device by using a PUCCH. Alternatively, the response message may be carried on all uplink symbols after the GP in the second type of subframe. In this case, the UE can use all the uplink symbols in a frequency division manner, that is, send the response message to the access network device by using a partial band set of all the uplink symbols, to implement sharing with another uplink channel, and improve coverage of the response message with accumulation of energy. Alternatively, the response message may be carried on a PUSCH of the second type of subframe. In this case, the UE may use the PUSCH in a frequency division manner, that is, send the response message to the access network device by using a partial band set of the PUSCH. Further, in a same cell, this manner may be used to carry a response message for a cell-edge user whereas a PUCCH may be used to carry a response message for a center user. In this way, resource conflicts between different UEs in a same cell are reduced. Alternatively, the response message may be carried on the last uplink symbol. In this case, a time for processing data by the UE can be increased.

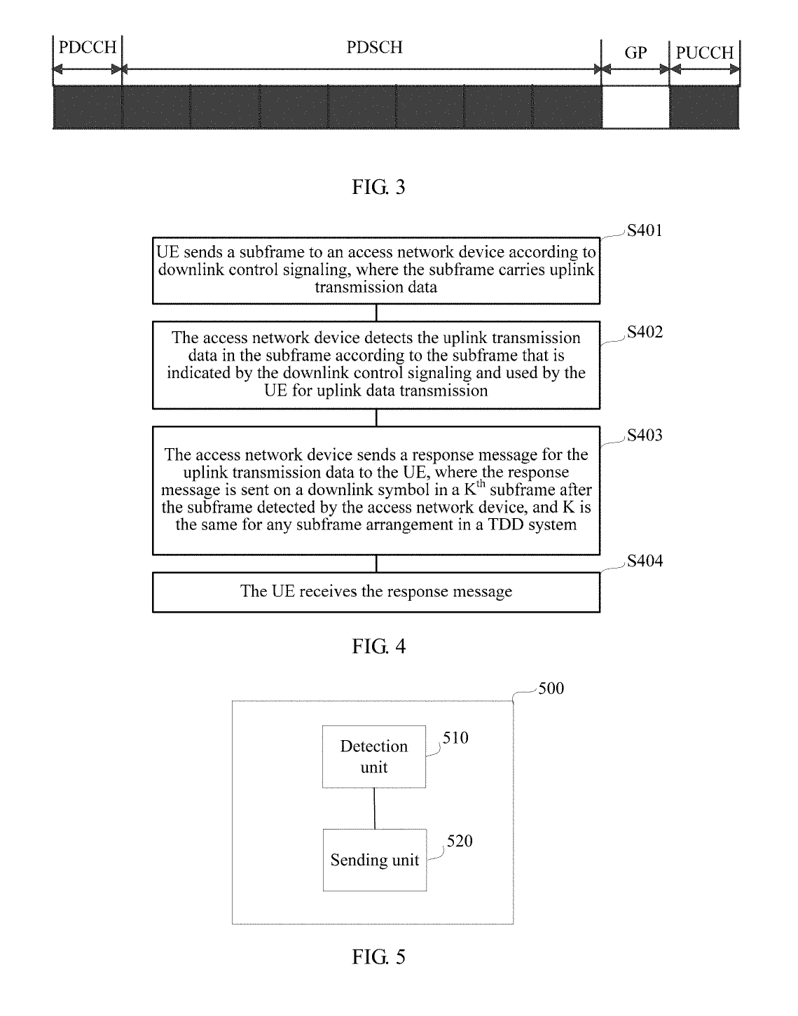

In many communications systems, due to hardware condition limitations, a relatively long processing time is required after the UE receives data. In this case, it is possible that the UE cannot feed back the response message in the uplink manner in the subframe at the (n+K)^{th} moment. If a feedback is performed in an (n+K+1)^{th} subframe, however, a feedback delay is increased. Therefore, further, a time sequence between symbols in the first type of subframe may be adjusted. For example, FIG. 3 shows a structure of an improved subframe of the first type. As shown in FIG. 3, a PUCCH originally arranged foremost in a time sequence is placed after a GP, and a subframe structure of a PDCCH, a PDSCH, the GP, and the PUCCH in a time sequence from left to right is formed. In this way, when the UE needs to feed back the response message in an uplink manner in the (n+K)^{th} subframe to the access network device, different from the first type of subframe for which a feedback needs to be performed on the beginning PUCCH of the subframe, for the improved subframe of the first type, downlink transmission data may be processed on the PDCCH, PDSCH, and GP of the subframe and a feedback may be performed on the last PUCCH. Therefore, a processing time of the UE is appropriately increased, and a feedback delay can still remain unchanged.

After receiving the response message fed back in an uplink manner by the UE, the access network device can determine, according to a specific situation, whether to retransmit data in a downlink manner to the UE.

It should be noted that the subframe arrangement in S203 is a subframe ratio in a configuration manner, that is, an arrangement sequence, by time, of different subframes in one configuration period.

According to the technical solutions provided in this embodiment of the present disclosure, in a TDD system, a feedback message is sent in a K^{th} subframe after a subframe for transmitting data, thereby reducing HARQ feedback complexity. In addition, an ACK or NACK feedback time is shortened by setting K, thereby greatly reducing a HARQ delay and meeting a transmission requirement for an ultralow delay. Meanwhile, by further improving a subframe structure, not only a processing time of a data receiving party is increased, but also a relatively short feedback delay can still be retained. Therefore, a desirable beneficial effect is achieved.

FIG. 4 is a flowchart of another information feedback method according to an embodiment of the present disclosure. The method is applied to uplink data transmission, UE sends uplink transmission data according to downlink control signaling of an access network device, and the access network device feeds back a response message indicating whether the uplink transmission data needs to be retransmitted. The method includes the following steps:

S401. UE sends a subframe to an access network device according to downlink control signaling, where the subframe carries uplink transmission data.

S402. The access network device detects the uplink transmission data in the subframe according to the subframe that is indicated by the downlink control signaling and used by the UE for uplink data transmission.

S403. The access network device sends a response message for the uplink transmission data to the UE, where the response message is sent on a downlink symbol in a K^{th} subframe after the subframe detected by the access network device, and K is the same for any subframe arrangement in the TDD system.

S404. The UE receives the response message.

Generally, signaling transmission or data transmission between the access network device and the UE is described by using a subframe as a time unit.

A manner of data exchange between the access network device and the UE may be that, when the UE needs to transmit data to the access network device in an uplink manner, the UE may first send scheduling request signaling to the access network device. Optionally, the UE may send the scheduling request signaling to the access network device by using a PUCCH. The scheduling request signaling may be a scheduling request indication (SRI), so as to inform the access network device that the UE has data to be transmitted and request the access network device to allocate a channel resource for uplink transmission.

When the channel resource can meet a requirement of the UE, the access network device may send the downlink control signaling to the UE. The downlink control signaling is used to instruct the UE to send uplink data. Optionally, the downlink control signaling includes: an uplink grant (UL Grant), which is used to indicate a time (that is, a subframe in which the uplink transmission data is located) for receiving the downlink transmission data by the UE, specific frequency information of the uplink transmission data or a modulation and coding scheme, and the like.

The UE sends, in a subframe at an n^{th} moment, the uplink transmission data to the access network device according to the downlink control signaling.

The access network device attempts to receive the uplink transmission data. When the access network device correctly receives the uplink transmission data, the access network device needs to feed back an ACK to the UE. When the access network device does not correctly receive the uplink transmission data, the access network device needs to feed back a NACK to the UE. The ACK or the NACK is a response message indicating whether transmission data is correctly received.

In this embodiment of the present disclosure, the response message is sent in the K^{th} subframe after the subframe that carries the uplink transmission data and is sent by the UE according to the downlink control signaling. For example, as previously described, when the UE sends, in the subframe at the n^{th} moment, the uplink transmission data, the access network device may feed back the response message in a downlink manner in a subframe at an (n+K)^{th} moment. K is a positive integer. The technical solutions provided in this embodiment of the present disclosure are intended to shorten a feedback time of the response message. Therefore, a shorter fixed period indicates a better effect, that is, a smaller value of K indicates a better effect. In practice, a value of K may be 1, 2, 3, or 4.

When the access network device feeds back the response message, the response message may be carried on a downlink symbol in a subframe. Optionally, the access network device may use two types of subframes shown in FIG. 1 to feed back the response message to the UE.

### (1) Feeding Back the Response Message by Using a First Type of Subframe

The response message may be carried on the second symbol (the first downlink symbol) in the first type of subframe, that is, the response message is sent to the UE by using a PDCCH, or the response message may be carried on at least two downlink symbols after the first uplink symbol in the first type of subframe. For example, the response message may be carried on all downlink symbols in the second type of subframe. In this case, the access network device may use all the downlink symbols in a frequency division manner, that is, send the response message to the UE by using a partial band set of all the downlink symbols, to implement sharing with another uplink channel, and improve coverage of the response message with accumulation of energy.

### (2) Feeding Back the Response Message by Using a Second Type of Subframe

The response message may be carried on the first symbol in the second type of subframe, that is, the response message is sent to the access network device by using a PDCCH.

When a PDCCH of a subframe of this type is extended to multiple consecutive downlink symbols, the response message may be accordingly carried on the multiple downlink symbols.

After receiving the response message fed back in a downlink manner by the access network device, the UE can determine, according to a specific situation, whether to retransmit data in an uplink manner to the access network device.

It should be noted that the subframe arrangement in S403 is a subframe ratio in a configuration manner, that is, an arrangement sequence, by time, of different subframes in one configuration period.

According to the technical solutions provided in this embodiment of the present disclosure, in a TDD system, a feedback message is sent in a K^{th} subframe after a subframe for transmitting data, thereby reducing HARQ feedback complexity. In addition, an ACK or NACK feedback time is shortened by setting K, thereby greatly reducing a HARQ delay and meeting a transmission requirement for an ultralow delay.

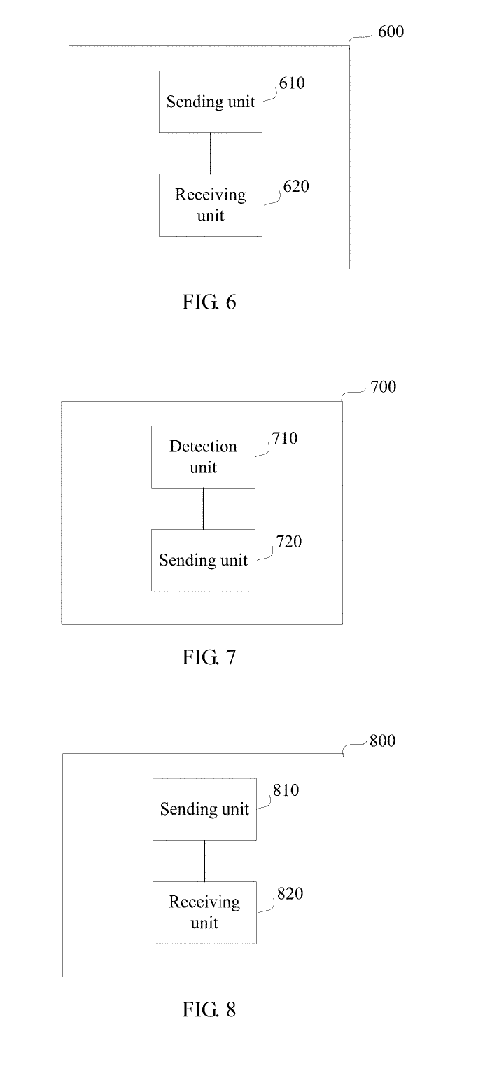

To perform an information feedback method provided in the embodiment shown in FIG. 2, an embodiment of the present disclosure provides user equipment 500 and an access network device 600, so as to perform downlink data transmission and an uplink feedback of a response message. As shown in FIG. 5, the user equipment includes a detection unit 510 and a sending unit 520. As shown in FIG. 6, the access network device includes a sending unit 610 and a receiving unit 620.

The detection unit 510 is configured to detect downlink transmission data in a received subframe.

The sending unit 520 is configured to send a response message for the downlink transmission data to the access network device, where the response message is sent by the UE on an uplink symbol in a K^{th} subframe after the received subframe, and K is the same for any subframe arrangement in a TDD system.

The sending unit 610 is configured to send the subframe to the user equipment UE, where the subframe carries the downlink transmission data.

The receiving unit 620 is configured to receive the response message sent by the UE.

Generally, signaling transmission or data transmission between the access network device 600 and the UE 500 is described by using a subframe as a time unit.

When the access network device 600 needs to transmit data to the UE in a downlink manner, the sending unit 610 may send, in a subframe at an n^{th} moment, downlink control signaling and downlink transmission data. The downlink control signaling is used to inform the UE that the access network device has downlink data to be transmitted. Optionally, the downlink control signaling includes: a downlink grant (DL Grant), which is used to indicate a time (that is, a subframe in which the downlink transmission data is located) for receiving the downlink transmission data by the UE, specific frequency information of the downlink transmission data or a modulation and coding scheme, and the like.

The UE 500 attempts to receive the downlink transmission data according to the downlink control signaling. When the detection unit 510 of the UE 500 detects the downlink transmission data and correctly receives the downlink transmission data, the sending unit 510 needs to feed back an ACK to the access network device 600. When the sending unit 510 does not detect the downlink transmission data or correctly receive the downlink transmission data, the UE needs to feed back a NACK to the access network device 600. The ACK or the NACK is a response message indicating whether transmission data is correctly received.

In this embodiment of the present disclosure, the response message is sent in a fixed period after the sending unit 610 sends the downlink transmission data. For example, as previously described, when the sending unit 610 of the access network device 600 sends, in the subframe at the n^{th} moment, the downlink control signaling and the downlink transmission data, the sending unit 520 of the UE 500 may feed back the response message in an uplink manner in a subframe at an (n+K)^{th} moment. K is a positive integer. The technical solutions provided in this embodiment of the present disclosure are intended to shorten a feedback time of the response message. Therefore, a shorter fixed period indicates a better effect, that is, a smaller value of K indicates a better effect. In actual application, a value of K may be 1, 2, 3, or 4.

When the UE 500 feeds back the response message, the response message may be carried on an uplink symbol in a subframe. Optionally, the UE 500 may use two types of subframes shown in FIG. 1 to feed back the response message to the access network device 600. A specific implementation is already described in detail in the disclosure embodiment shown in FIG. 2, and reference may be made thereto. Details are not described herein.

After receiving the response message fed back in an uplink manner by the sending unit 520 of the UE 500, the receiving unit 620 of the access network device 600 can determine, according to a specific situation, whether to retransmit data in a downlink manner to the UE.

It should be noted that the subframe arrangement in this embodiment is a subframe ratio in a configuration manner, that is, an arrangement sequence, by time, of different subframes in one configuration period.

Optionally, functions of the access network device 600 and the UE 700 provided in this embodiment of the present disclosure may be cooperatively implemented by using a processor and a transceiver.

According to the technical solutions provided in this embodiment of the present disclosure, in a TDD system, a feedback message is sent in a K^{th} subframe after a subframe for transmitting data, thereby reducing HARQ feedback complexity. In addition, an ACK or NACK feedback time is shortened by setting K, thereby greatly reducing a HARQ delay and meeting a transmission requirement for an ultralow delay. Meanwhile, by further improving a subframe structure, not only a processing time of a data receiving party is increased, but also a relatively short feedback delay can still be retained. Therefore, a desirable beneficial effect is achieved.

To perform another information feedback method provided in the embodiment shown in FIG. 4, an embodiment of the present disclosure provides an access network device 700 and user equipment 800, so as to perform uplink data transmission and a downlink feedback of a response message. As shown in FIG. 7, the access network device 700 includes a detection unit 710 and a sending unit 720. As shown in FIG. 8, the user equipment 800 includes a sending unit 810 and a receiving unit 820.

The detection unit 710 is configured to detect uplink transmission data in a subframe according to the subframe that is indicated by downlink control signaling and used for uplink data transmission.

The sending unit 720 is configured to send, to the UE, the response message for the uplink transmission data, where the response message is sent on a downlink symbol in a K^{th} subframe after the subframe detected by the access network device, and K is the same for any subframe arrangement in the TDD system.

The sending unit 810 is configured to send the subframe to the access network device according to the downlink control signaling, where the subframe carries the uplink transmission data.

The receiving unit 820 is configured to receive the response message.

Generally, signaling transmission or data transmission between the UE 800 and the access network device 700 is described by using a subframe as a time unit.

When the UE 800 needs to transmit data to the access network device 700 in an uplink manner, the sending unit 810 may first send scheduling request signaling to the access network device. Optionally, the sending unit 810 may send the scheduling request signaling to the access network device by using a PUCCH. The scheduling request signaling may be a scheduling request indication (SRI), so as to inform the access network device that the UE has data to be transmitted and request the access network device to allocate a channel resource for uplink transmission.

When the channel resource can meet a requirement of the UE 800, the access network device 700 may send the downlink control signaling to the UE. The downlink control signaling is used to instruct the UE to send uplink data. Optionally, the downlink control signaling includes: an uplink grant (UL Grant), which is used to indicate a time (that is, a subframe in which the uplink transmission data is located) for receiving the downlink transmission data by the UE, specific frequency information of the uplink transmission data or a modulation and coding scheme, and the like.

The sending unit 810 of the UE 800 sends, in a subframe at an n^{th} moment, the uplink transmission data to the access network device 700 according to the downlink control signaling.

The access network device 700 attempts to receive the uplink transmission data. When the detection unit 710 of the access network device 700 detects the uplink transmission data and correctly receives the uplink transmission data, the sending unit 720 needs to feed back an ACK to the UE 800. When the detection unit 710 of the access network device 700 does not detect the uplink transmission data or correctly receive the uplink transmission data, the sending unit 720 needs to feed back a NACK to the UE 800. The ACK or the NACK is a response message indicating whether transmission data is correctly received.

In this embodiment of the present disclosure, the response message is sent in the K^{th} subframe after the subframe that carries the uplink transmission data and is sent by the UE according to the downlink control signaling. For example, as previously described, when the sending unit 810 of the UE 800 sends, in the subframe at the n^{th} moment, the uplink transmission data, the sending unit 720 of the access network device 700 may feed back the response message in a downlink manner in a subframe at an (n+K)^{th} moment. K is a positive integer. The technical solutions provided in this embodiment of the present disclosure are intended to shorten a feedback time of the response message. Therefore, a shorter fixed period indicates a better effect, that is, a smaller value of K indicates a better effect. In practice, a value of K may be 1, 2, 3, or 4.

When the access network device 700 feeds back the response message, the response message may be carried on a downlink symbol in a subframe. Optionally, the access network device 700 may use two types of subframes shown in FIG. 1 to feed back the response message to the UE 800. A specific implementation is already described in detail in the disclosure embodiment shown in FIG. 4, and reference may be made thereto. Details are not described herein.

After receiving the response message that is fed back in a downlink manner by the access network device and indicates whether downlink data needs to be retransmitted, the UE 800 can determine, according to a specific situation, whether to retransmit data in an uplink manner to the access network device 700.

It should be noted that the subframe arrangement in this embodiment is a subframe ratio in a configuration manner, that is, an arrangement sequence, by time, of different subframes in one configuration period.

Optionally, functions of the access network device 700 and the UE 800 provided in this embodiment of the present disclosure may be cooperatively implemented by using a processor and a transceiver.

According to the technical solutions provided in this embodiment of the present disclosure, in a TDD system, a feedback message is sent in a K^{th} subframe after a subframe for transmitting data, thereby reducing HARQ feedback complexity. In addition, an ACK or NACK feedback time is shortened by setting K, thereby greatly reducing a HARQ delay and meeting a transmission requirement for an ultralow delay.

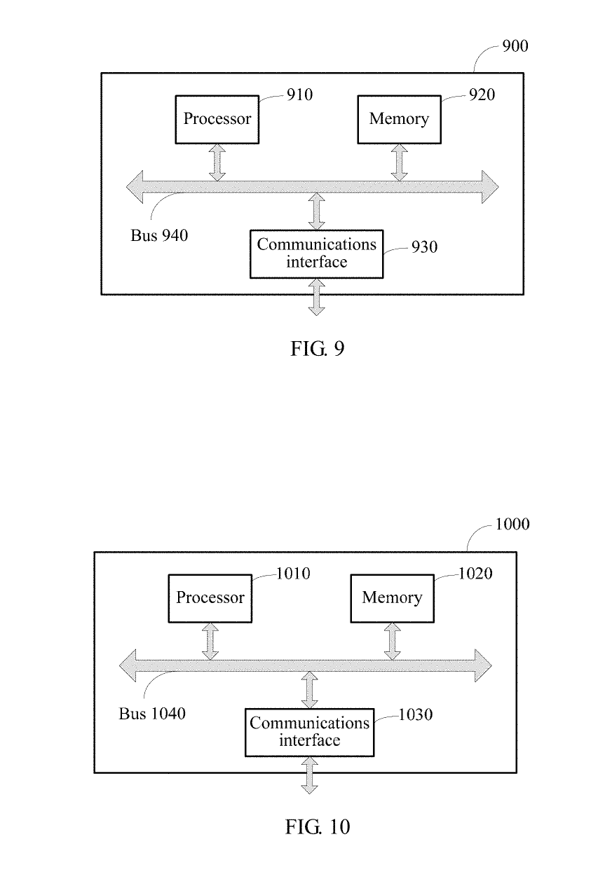

FIG. 9 is a schematic structural diagram of another user equipment 900 according to an embodiment of the present disclosure. As shown in FIG. 9, a mobility management device 900 includes a processor 910, a memory 920, a communications interface 930, and a bus 940. The memory 920 stores an execution instruction. When the device runs, the processor 910 communicates with the memory 920 by using the bus 940. The processor 910 receives information by using the communications interface 930, and performs, according to a computer instruction stored in the memory 920, the steps of the method disclosed in the method embodiment provided in FIG. 2 in the embodiments of the present disclosure.

FIG. 10 is a schematic structural diagram of another access network device 1000 according to an embodiment of the present disclosure. As shown in FIG. 10, a mobility management device 1000 includes a processor 1010, a memory 1020, a communications interface 1030, and a bus 1040. The memory 1020 stores an execution instruction. When the device runs, the processor 1010 communicates with the memory 1020 by using the bus 1040. The processor 1010 receives information by using the communications interface 1030, and performs, according to a computer instruction stored in the memory 1020, the steps of the method disclosed in the method embodiment provided in FIG. 2 in the embodiments of the present disclosure.

FIG. 11 is a schematic structural diagram of another access network device 1100 according to an embodiment of the present disclosure. As shown in FIG. 11, a mobility management device 1100 includes a processor 1110, a memory 1120, a communications interface 1130, and a bus 1140. The memory 1120 stores an execution instruction. When the device runs, the processor 1110 communicates with the memory 1120 by using the bus 1140. The processor 1110 receives information by using the communications interface 1130, and performs, according to a computer instruction stored in the memory 1120, the steps of the method disclosed in the method embodiment provided in FIG. 4 in the embodiments of the present disclosure.

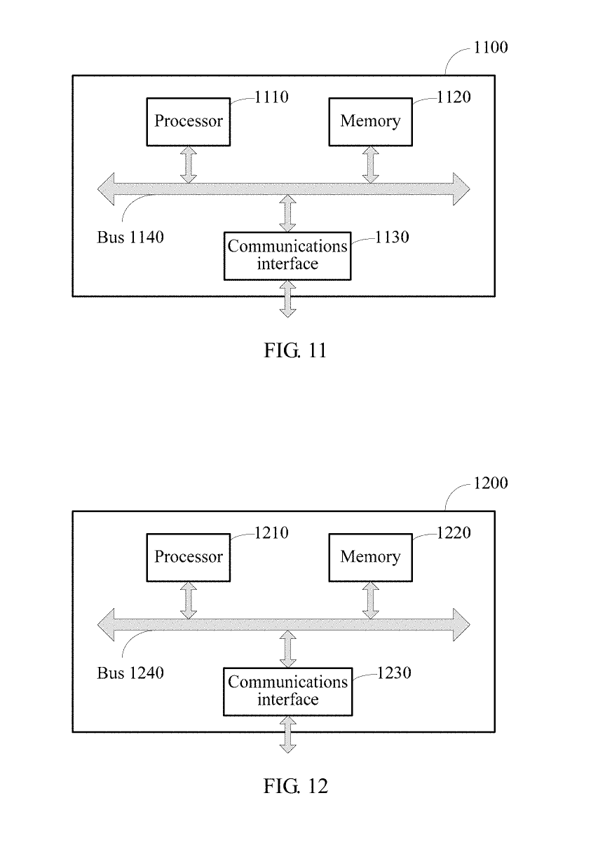

FIG. 12 is a schematic structural diagram of another UE 1200 according to an embodiment of the present disclosure. As shown in FIG. 12, a mobility management device 1200 includes a processor 1210, a memory 1220, a communications interface 1230, and a bus 1240. The memory 1220 stores an execution instruction. When the device runs, the processor 1210 communicates with the memory 1220 by using the bus 1240. The processor 1210 receives information by using the communications interface 1230, and performs, according to a computer instruction stored in the memory 1220, the steps of the method disclosed in the method embodiment provided in FIG. 4 in the embodiments of the present disclosure.

The processor shown in FIG. 9 to FIG. 12 may be a general purpose processor, a digital signal processor (DSP), an application-specific integrated circuit (ASIC), a field programmable gate array (FPGA) or another programmable logical device, a discrete gate or transistor logic device, or a discrete hardware component. The general purpose processor may be a microprocessor, or the processor may be any conventional processor, or the like. Steps of the methods disclosed with reference to the embodiments of the present disclosure may be directly performed and accomplished by means of a hardware decoding processor, or may be performed and accomplished by using a combination of hardware and software modules in the decoding processor. Computer instructions may be located in a mature storage medium in the art, such as a random access memory, a flash memory, a read-only memory, a programmable read-only memory, an electrically erasable programmable memory, or a register. The storage medium is located in the memory, and a processor reads information in the memory and completes steps in methods in the embodiments in combination with hardware of the processor.

A person of ordinary skill in the art may understand and implement all procedures in the foregoing embodiments, and all the procedures can be implemented computer program instructions in combination with related hardware.

In the solutions provided in the embodiments of the present disclosure, the “first”, “second”, and the like are intended only to distinguish different objects such as different types of subframes, and impose no substantial limitation.

In the foregoing embodiments, limitations of application scenarios and the like are only used to describe but not to limit specific technical solutions of the present disclosure. That is, modifications may be made to the technical solutions recorded in the foregoing embodiments, or equivalent substitutions may be made to the technical features in the foregoing embodiments. However, these modifications and substitutions do not depart from the protection scope of the present disclosure.

What is claimed is:

1. An information feedback method, comprising:
detecting, by a user equipment (UE) in a time division duplex (TDD) system, downlink transmission data in a received subframe; and
sending, by the UE, a response message for the downlink transmission data to an access network device, wherein the response message is sent by the UE on an uplink symbol in a K^{th} subframe after the received subframe, and K is the same for any subframe arrangement in the TDD system, wherein K is a positive integer, and the response message is a hybrid automatic repeat request (HARD) response message.

2. The method according to claim 1, wherein the K^{th} subframe comprises an uplink symbol and a downlink symbol.

3. The method according to claim 2, wherein the uplink symbol in the K^{th} subframe is located before the downlink symbol in the subframe.

4. The method according to claim 2, wherein the downlink symbol in the K^{th} subframe is located before the uplink symbol in the subframe, there are multiple uplink symbols in the subframe, a guard period exists between the downlink symbol and the uplink symbol in the subframe, and the response message is carried on any uplink symbol after the guard period or on at least two uplink symbols after the guard period.

5. The method according to claim 2, wherein the downlink symbol in the K^{th} subframe is located before the uplink symbol in the subframe, there is one uplink symbol in the subframe, and a guard period exists between the downlink symbol and the uplink symbol in the subframe.

6. A device, comprising:
a processor; and
a non-transitory computer-readable storage medium coupled to the processor and storing programming instructions for execution by the processor, the programming instructions instruct the processor to:
detect downlink transmission data in a received subframe in a time division duplex (TDD) system; and
send a response message for the downlink transmission data to an access network device, wherein the response message is sent by the device on an uplink symbol in a K^{th} subframe after the received subframe, and K is the same for any subframe arrangement in the TDD system, wherein K is a positive integer, and the response message is a hybrid automatic repeat request (HARQ) response message.

7. The device according to claim 6, wherein the K^{th} subframe comprises an uplink symbol and a downlink symbol.

8. The device according to claim 7, wherein the uplink symbol in the K^{th} subframe is located before the downlink symbol in the subframe.

9. The device according to claim 7, wherein the downlink symbol in the K^{th} subframe is located before the uplink symbol in the subframe, there are multiple uplink symbols in the subframe, a guard period exists between the downlink symbol and the uplink symbol in the subframe, and the response message is carried on any uplink symbol after the guard period or on at least two uplink symbols after the guard period.

10. The device according to claim 7, wherein the downlink symbol in the K^{th} subframe is located before the uplink symbol in the subframe, there is one uplink symbol in the subframe, and a guard period exists between the downlink symbol and the uplink symbol in the subframe.

11. An information feedback method, comprising:
sending, by an access network device in a time division duplex (TDD) system, a subframe to a user equipment (UE), wherein the subframe carries downlink transmission data; and
receiving, by the access network device, a response message that is sent by the UE for the downlink transmission data, wherein the response message is sent on an uplink symbol in a K^{th} subframe after the subframe sent by the access network device, and K is the same for any subframe arrangement in the TDD system, wherein K is a positive integer, and the response message is a hybrid automatic repeat request (HARQ) response message.

12. The method according to claim 11, wherein the K^{th} subframe comprises an uplink symbol and a downlink symbol.

13. The method according to claim 12, wherein the uplink symbol in the K^{th} subframe is located before the downlink symbol in the subframe.

14. The method according to claim 12, wherein the downlink symbol in the K^{th} subframe is located before the uplink symbol in the subframe, there are multiple uplink symbols in the subframe, a guard period exists between the downlink symbol and the uplink symbol in the subframe, and the response message is carried on any uplink symbol after the guard period or on at least two uplink symbols after the guard period.

15. The method according to claim 12, wherein the downlink symbol in the K^{th} subframe is located before the uplink symbol in the subframe, there is one uplink symbol in the subframe, and a guard period exists between the downlink symbol and the uplink symbol in the subframe.

16. A device, comprising:
a processor; and
a non-transitory computer-readable storage medium coupled to the processor and storing programming instructions for execution by the processor, the programming instructions instruct the processor to:
send a subframe to a user equipment (UE) in a time division duplex (TDD) system, wherein the subframe carries downlink transmission data; and
receive a response message that is sent by the UE for the downlink transmission data, wherein the response message is sent on an uplink symbol in a K^{th} subframe after the subframe sent by the access network device, and K is the same for any subframe arrangement in the TDD system, wherein K is a positive integer, and the response message is a hybrid automatic repeat request (HARD) response message.

17. The device according to claim 16, wherein the K^{th} subframe comprises an uplink symbol and a downlink symbol.

18. The device according to claim 17, wherein the uplink symbol in the K^{th} subframe is located before the downlink symbol in the subframe.

19. The device according to claim 17, wherein the downlink symbol in the K^{th} subframe is located before the uplink symbol in the subframe, there are multiple uplink symbols in the subframe, a guard period exists between the downlink symbol and the uplink symbol in the subframe, and the response message is carried on any uplink symbol after the guard period or on at least two uplink symbols after the guard period.

20. The device according to claim 17, wherein the downlink symbol in the K^{th} subframe is located before the uplink symbol in the subframe, there is one uplink symbol in the subframe, and a guard period exists between the downlink symbol and the uplink symbol in the subframe.
